(19) United States
(12) Patent Application Publication
(10) Pub. No.: US 2005/0202130 A1
(43) Pub. Date: Sep. 15, 2005

(54) Synthetic gut sections closed at one end

(76) Inventors: Christian Auf Der Heide, Osnabrueck (DE); Dirk Auf Der Heide, Alfhausen (DE); Ulrich Delius, Frankfurt (DE); Bernhard Feron, Wiesbaden (DE); Jens Foegler, Taunusstein (DE); Bernd Adolf Lang, Wiesbaden (DE); Robert Wilfer, Versmold (DE)

Correspondence Address: CONNOLLY BOVE LODGE & HUTZ LLP, SUITE 800, 1990 M STREET NW, WASHINGTON, DC, 20036-3425, US

(21) Appl. No.: 10/517,059

(22) PCT Filed: Jun. 2, 2003
(86) PCT No.: PCT/EP03/05737

§ 371 Date: Dec. 3, 2004

(30) Foreign Application Priority Data
Jun. 7, 2002 (DE) 10225619.5

(51) Int. Cl. A23G 1/00

(52) U.S. Cl. 426/135

(57) ABSTRACT

A section of a tubular foodstuff casing closed at one end with an end with a flat transverse seam, wherein the casing comprises a heat-sealable polymer material, or has a layer or a coating thereof on an inner side thereof, or wherein the casing comprises (i) uncoated or coated textile material, (ii) knitted material and/or, (iii) nonwoven, or non-fiber-reinforced or fiber-reinforced cellulose, where said flat transverse seam comprises a jointing seam comprising a sealed seam and/or a adhesive seam.

The invention relates to sections of a tubular foodstuff casing, closed at one end with a flat transverse seam. It also relates to a process for the production of the sections, and to a process for the packing of the sections.

Synthetic casing sections closed at one end are well known. They are in particular used for the production of spreadable raw sausage, e.g. for the product known as “Pfeffersäckchen”. The sections generally have a sewn seam at one end, and if appropriate use a closure band. This may be made of a swellable sewing material in order to make the seam particularly impermeable to fat. The sewn seams are produced on the sections individually, a very time-consuming and therefore costly process.

DE-A 100 01 699 describes a process for the production of closures on synthetic casing sections, where the open end of each section is closed via a grooved or folded closure band, sewn onto one end. The closure band increases the mechanical stability of the closure and its impermeability to fat.

However, sewn closures are problematic even when bands are used. Discharge of fat cannot be completely prevented, but can only be minimized, because of the perforation produced by sewing.

Depending on the embodiment (e.g. teewurst in fiber casing), from 2 to 6% fat discharge can occur. This is regarded as particularly disadvantageous by the sausage processor, because smoking plants are contaminated, and by the consumer, because the fat deposit in the vacuum processor, because smoking plants are contaminated, and by the consumer, because the fat deposit in the vacuum pack impairs appearance. Furthermore, the amount of fat discharged is in principle related to the undesired alteration of the taste of the sausage. In parallel with the discharge of fat, mention may also be made here of loss of moisture and the related drying effect.

The subject matter of U.S. Pat. No. 3,965,537 is a tubular foodstuff casing composed of edible material, the casing being shirred in sections. The edible material is generally collagen, i.e. a natural protein. Each of the sections has been closed at one end via one rounded, one oblique, or two obliquely meeting seams, preferably produced via heat-sealing.

DE-U 201 19 904 discloses a tubular sausage casing composed of plastics material, the casing being closed at one end via a welded seam. The welded seam may have been produced via ultrasound, high-frequency welding, or heat impulse welding. In addition, a U-shaped adhesive tape generally surrounds the closed end region. The result is that the end of the sausage casing is particularly leakproof, and discharge of liquid is prevented.

It was therefore an object of the invention to develop a process which considerably reduces or indeed entirely prevents fat discharge when the synthetic casing section is closed, so that a second pack is sometimes unnecessary. In addition to this, the intention is that the production of the sections closed at one end should become more rational and less expensive than hitherto.

The object has been achieved via the closure at one end of the synthetic casing with a flat seam, which is a jointing seam sewn which can be produced via welding, sealing, or adhesive bonding. Where appropriate, the closed end also has a decorative seam or a printed imitation of a seam, e.g. with feel enhanced by an embossment.

The present invention therefore provides sections of a tubular foodstuff casing closed at one end with a flat transverse seam, wherein the casing is composed of a heat-sealable polymer material, or has a layer or a coating thereof on the inner side, or wherein the casing is composed of uncoated or coated textile material, composed or knitted material, composed of nonwoven, or composed of non-fiber-reinforced or fiber-reinforced cellulose, where the transverse seam is a jointing seam which is a sealed seam or adhesive seam.

The tubular casing has one or more layers. For its production, use may be made of a very wide variety of materials. Examples of suitable materials are polyolefins (specifically polyethylene, polypropylene, polybutylene, ethylene-α-olefin copolymers, propylene-α-olefin copolymers, or ethylene-propylene-α-olefin terpolymers), polyamides (specifically aliphatic and partly aromatic polyamides, and also mixtures of these), polyesters, polyvinyl chloride, polyvinylidene chloride, polyurethane, polyacrylonitrile, polyether, polycarbonate, thermoplastic starch, starch derivatives (such as starch acetate), ethylene-vinyl acetate copolymers. Mixtures composed of two or more of the abovementioned materials may also be used. In the case of the multilayer casings, use may also be made of other materials with specific properties, for example moisture-sensitive sensitive polymers with oxygen-barrier properties (i.e. in particular ethylene-vinyl alcohol (EVOH) copolymers) or polymers with adhesion-promoting properties. It is also possible to use casings based on (regenerated) cellulose, and these may, where appropriate, have a fiber reinforcement, or else casings based on uncoated or coated (specifically acrylate-coated) textile material.

The wall thickness of the tubular casing depends on the nature of the material, on the subsequent use, and also on the caliber (a higher-caliber casing generally also having higher wall thickness). It is generally from 30 to 150 μm, preferably from 40 to 90 μm. Casings composed of coated textile material are generally somewhat thicker (generally from about 50 to 200 μm).

The casing may be an unoriented or oriented casing, and the oriented casings here have generally been biaxially oriented and generally also heat-set. Examples of suitable casings are therefore those composed of unoriented polyamide (uPA) or of at least one layer composed of uPA. The biaxial orientation may take place in a blown-film process or in what is known as a “double-bubble” process. The longitudinal and transverse shrinkage of the oriented tubular foodstuff casing of heating to up to 90° C. (water bath, 5 min) is generally not more than 20%, preferably not more than 15%.

Heat-sealable casings are particularly useful for the purposes of the present invention. These are generally multilayer casings in which at least the inner layer (subsequently in contact with the foodstuff) is heat-sealable. It is generally produced via coextrusion, advantageously with the aid of an annular coextrusion die.

The heat-sealable layer located on the inner side is generally composed of a thermoplastic material whose melting point is lower than that of the actual backing layer. For practical purposes, preference is given to a sealable layer composed of a thermoplastic material whose melting point is up to 150° C. The heat-sealable layer therefore comprises as substantial constituent or as principal constituent, by way of example, a polyolefin, in particular a polyethylene (specifically an LDPE or LLDPE) or an ethylene copolymer, specifically an ethylene-propylene copolymer, an ethylene-vinyl acetate copolymer, or an ethylene-(meth)acrylic acid copolymer or a salt thereof, and the last named may also be termed ionomers. Ionomers moreover have very good adhesion-promoting properties with respect to various other plastics and therefore tend to prevent undesired delamination of the multilayer foodstuff casing. The heat-sealability may moreover be improved with the aid of metal salts of fatty acid, e.g. calcium stearate.

A heat-sealable coating may also be sufficient for some applications, instead of a heat-sealable layer on the inner side. This coating can be produced via application of a corresponding coating liquid and subsequent drying. However, the sealable coatings thus produced are relatively thin (from about 10 to 300 nm), and there are therefore restrictions on the resultant achievable sealed seam strength. Furthermore, the inner side of seamless tubular films can be coated only at high technical cost, and therefore this alternative is in practice only important for flat films which then are sealed to give tubular films in a further step.

The backing layer(s) in the multilayer tubular foodstuff casing are preferably composed of aliphatic and/or partly aromatic polyamide and/or copolyamide (such as PA 6, PA 66, PA 6I/6T, PA 6/66, PA 46, PA 610, or PA 612). These polyamide layers intrinsically have a certain degree of barrier action with respect to oxygen and aroma constituents. They absorb up to about 6% by weight of water. This applies particularly to layers composed of aliphatic polyamide or copolyamide. Where appropriate, the polyamides or copolyamides of the backing layer(s) may have been blended with other polymers, in particular with polyolefins. Their proportion is then generally less than 50% by weight, based on the weight of the backing layer. It is especially the mechanical properties of the foodstuff casing that are determined via the backing layer(s). The backing layers generally have a thickness of from 10 to 100 μm, preferably from 20 to 60 μm.

One preferred embodiment of the foodstuff casing moreover comprises at least one water-vapor- and/or oxygen-barrier layer. The result is to eliminate or markedly reduce weight loss on storage, i.e. drying the foodstuff. A good oxygen barrier is particularly important for highly air-sensitive foodstuffs. By way of example, barrier layers are composed of polyvinylidene chloride (PVDC) or of vinylidene chloride copolymers, polyvinyl chloride (PVC), ethylene-vinyl alcohol (EVOH) copolymers, or polyethylene terephthalate (PET). Barrier layers composed of chlorine-free materials are more advantageous for environmental reasons. The barrier layers generally have a thickness of (in each case) from 4 to 25 μm, preferably from 5 to 15 μm.

Between the individual layers there are also frequently relatively thin adhesive layers (thickness therefore less than about 4 μm). Adhesive layers are necessary or advantageous if layers composed of different polymers come into contact. By way of example, polyolefin layers and polyamide layers have only relatively low mutual adhesion, and this therefore makes it advisable to use adhesive layers. However, adhesion-promoting components may also have been directly admixed with one or both of the layers coming into contact. Examples of suitable components of this type are polyolefins which have functional groups (in particular carboxy groups).

The inner side of the tubular foodstuff casing has always to have adequate adhesion to the emulsion. Excessive adhesion has to be avoided, in order to permit fully satisfactory subsequent removal of the foodstuff casing by peeling. However, excessively weak adhesion is also to be avoided, otherwise what is known as a gel deposit can easily form between sausage emulsion and casing, and this is often perceived by consumers as a quality defect.

The tubular foodstuff casing usually has a straight shape. However, it may also have been bent (ring casing) or be formed regularly or irregularly (imitation of natural gut). The caliber of the casing is generally from 30 to 60 mm for ring casing, from 20 to 50 mm for small-caliber synthetic casing, from 50 to less than 80 mm for medium-caliber synthetic casing. Casings suitable for the purposes of the present invention are usually seamless, i.e. have no longitudinal seams. However, they may in principle be produced from flat film which is then folded to give a tube, which is then secured via welding or via sealing—if appropriate with use of a sealing band. However, the casing frequently does not have the same mechanical strength and the same shrinkage properties in the region of the longitudinal seam as in the other regions of the casing. Leaks can also occur. Casings with longitudinal seam are therefore generally less preferred.

Markings printed onto the foodstuff casing (print marks) and corresponding scanning sensors can be used to control precisely where the flat sealed seam or adhesive seam is to be produced.

In addition to the sealed seam or adhesive seam, a sewn seam may be present. This may be a “genuine” seam, in which the sewing material passes through the casing, and which then also contributes to the mechanical stability of the end closure. However, care then has to be taken that the perforation of the casing brought about by the sewing needle does not extend beyond the region of the sealed seam or adhesive seam, in order not to increase the likelihood of leakage of fat. It can be advantageous here to use a sewing material composed of a swellable material. Suitable materials for this purpose are known from the textile industry. The seam produced with sewing material also has a decorative function. Use of single- or multicolor sewing material can further raise the level of this decorative effect. In addition, this can also be used to indicate the factory of origin.

In another embodiment, the seam is located on a separate strip of material and this decorative seam or braid is applied to, or immediately adjacent to, the sealed seam, or adhesive seam. The bonding of the braid to the casing may in turn take place via sealing, welding, or adhesive bonding. Where appropriate, therefore, the sealing or adhesive bonding of the casing to produce the flat transverse seam and the application of the braid may have been combined in a single step. The combination mentioned also provides mechanical reinforcement of the transverse seam.

Finally, the sewn seam can also be imitated via embossing or printing. Here again, care has to be taken to avoid damage to the sealed seam or adhesive seam.

An adhesive seam can be produced with the aid of suitable adhesives, in particular hot-melt adhesives or contact adhesives. It has the advantage that it can also close casings composed of nonsealable and non-weldable material. These are in particular casings composed of uncoated or coated textile material (in particular composed of acrylate-coated woven material), composed of knitted products, composed of nonwoven, or composed of non-fiber-reinforced or fiber-reinforced cellulose (fiber casing). The nature of the adhesive depends on the casing material. For example, polyurethane adhesives or PVDC dispersion adhesives are particularly suitable for fiber casings. Acrylate adhesives are also generally suitable.

In order to permit production of an adhesive seam, however, the casing must previously have been cut into individual sections of appropriate length. In the case of the sealed seam, that is not necessary. Here, the casing can be rolled up (again) after application of the seam and, if appropriate, of the other applications described. The casing is then not separated into individual sections until immediately prior to stuffing. This “stuffing on the roll” permits a high degree of simplification and automation of the production of the sausages. DE-A 102 17 132, which is not a prior publication, describes an appropriate process for automatic stuffing, and also an apparatus for that purpose.

Some types of casing are permeable to hot smoke or cold smoke. By way of example, this applies to the non-fiber-reinforced or fiber-reinforced casings based on regenerated cellulose, and also to casings based on thermoplastic starch. Others may have been impregnated on the inner side with liquid smoke or dry smoke. This particularly applies to the single- or multilayer casings described above and based on synthetic polymers which have low permeability not only to water vapor and oxygen but also to hot smoke or cold smoke.

Processes and apparatus for the sealing or adhesive bonding of a tubular foodstuff casing are known per se. Apparatus for heat-sealing generally encompasses heated sealing jaws which are brought directly into contact with the surfaces to be sealed.

Casing sections of appropriate length can be shirred to give what are known as sticks. These are then correspondingly short (therefore also termed “ministicks”). These ministicks are preferably ready for stuffing, i.e. they require no prior water treatment or other pretreatment.

Once the sections have been stuffed, the other end of the casing is closed in a conventional manner, for example via a plastics or metal clip. Tying with yarn is also possible, although more complicated.

### EXAMPLE 1

### Teewurst Bags

Bags with an adhesive seam and additional sewn closure were produced from a fiber-reinforced casing based on cellulose (®NaloFaser) of caliber 40. The bags could be stuffed without difficulty with teewurst composition and then cold-smoked.

### EXAMPLE 2

### Long-Shelf-Life-Sausage Bags

Bags with a sealed seam and often with an embossed or printed decorative seam were produced from a single-layer, seamless casing (®NaloStar) with a wall in essence composed of about 40% by weight of thermoplastic starch and 60% by weight of polyurethane and a diameter of 45 mm, the wall thickness being 100 μm. The bags could be stuffed without difficulty with long-shelf-life sausage composition and then subjected to a ripening process.

### EXAMPLE 3

### Liver-Sausage Bags

Bags with a sealed seam and decorative seam were produced from a three-layer, seamless casing with PA/PE/PA layer structure (®NaloShape) with a diameter of 50 mm and a wall thickness of 55 μm, and these were then stuffed with liver sausage composition and then cooked. The bags could be processed without difficulty.

1. A section of a tubular foodstuff casing closed at one end with a flat transverse seam, wherein the seam is a jointing seam.

2. The section as claimed in claim 1, wherein the jointing seam comprises a sealed seam, welded seam, or adhesive seam.

3. The section as claimed in claim 1, wherein the foodstuff casing comprises a heat-sealable or weldable polymer material.

4. The section as claimed in claim 1, wherein the foodstuff casing has a heat-sealable layer or a heat-sealable coating on an inner side thereof.

5. The section as claimed in claim 2, wherein the foodstuff casing has been biaxially oriented, and if appropriate also heat-set.

6. The section as claimed in claim 2, wherein, parallel to the sealed seam, welded seam, or adhesive seam, there is a sewn seam.

7. The section as claimed in claim 6, wherein the sewn seam has been applied on a separate strip of material located on or immediately adjacent to the sealed seam, welded seam or adhesive seam.

8. The section as claimed in claim 6, wherein the sewn seam has been imitated via an embossment on or adjacent to the sealed seam, welded seam or adhesive seam.

9. The section as claimed in claim 6, wherein the sewn seam has been imitated via a print applied to or adjacent to the sealed seam, welded seam or adhesive seam.

10. The section as claimed in claim 1, which has been pre-smoked.

11. The section as claimed in one or more of claim 1, which has been shirred to give a short stick.

12. The section as claimed in claim 1, which, is not separated from other identical sections and has been wound up on a roll.

13. A section of a tubular foodstuff casing closed at one end with an end with a flat transverse seam, wherein the casing comprises a heat-sealable polymer material, or has a layer or a coating thereof on an inner side thereof, or wherein the casing comprises (i) uncoated or coated textile material, (ii) knitted material and/or, (iii) nonwoven, or non-fiber-reinforced or fiber-reinforced cellulose, where said flat transverse seam comprises a jointing seam comprising a sealed seam and/or a adhesive seam.

14. The section as claimed in claim 13, wherein the foodstuff casing has been biaxially oriented, and, if appropriate, also heat-set.

15. The section as claimed in claim 13, wherein the foodstuff casing comprises a water-vapor- and/or an oxygen-barrier layer.

16. The section as claimed in claim 13, wherein, parallel to the sealed seam or adhesive seam, there is a sewn seam.

17. The section as claimed in claim 16, wherein the sewn seam has been applied on a separate strip of material located on or immediately adjacent to the sealed seam or adhesive seam.

18. The section as claimed in claim 16, wherein the sewn seam has been imitated via an embossment on or adjacent to the sealed seam or adhesive seam.

19. The section as claimed in claim 16, wherein the sewn seam has been imitated via a print applied to or adjacent to the sealed seam or adhesive seam.

20. The section as claimed in claim 13, which has been pre-smoked.

21. The section as claimed in claim 13, which has been shirred to give a short stick.

22. The section as claimed in claim 13, which, has not been separated from other identical sections and has been wound up on a roll.
